(19) United States
(12) Patent Application Publication
(10) Pub. No.: US 2017/0061725 A1
(43) Pub. Date: Mar. 2, 2017

(54) Frozen Freezer Pack

(71) Applicant: Sherry J. Cerny, Salunga, PA (US)

(72) Inventor: Sherry J. Cerny, Salunga, PA (US)

(21) Appl. No.: 14/843,971

(22) Filed: Sep. 2, 2015

(51) Int. Cl. G07F 9/10

(52) U.S. Cl. CPC G07F 9/105

(57) ABSTRACT

This invention relates to a cold pack vending machine by which a user may keep food products cool outside of a refrigerator or freezer. The machine consists of a cold pack refrigerating system with freezer elements enclosed inside a cabinet that keeps the cold packs of different sizes, placed on shelves, frozen. A delivery system with hangers connected to a computing system delivers the selected cold pack for use.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of vending machines. The invention, particularly relates to cold pack vending machines which can be readily used to keep food material cold when placed outside refrigerator or freezer.

(2) Background of the Invention

To break the continuation of work-office routine a lot of families take vacations or go on camping by river side or forest. While going on camping people take along a lot of food stuff with them to the site of camping. Sometimes, the food stuff might even have a very short shelf life or something like an ice cream, cold drinks or bear may get warm. To overcome this, a lot of people carry with them a box filled with ice, which stores ice for a long time and also helps store perishable food stuffs for some time.

While camping, the box filled with ice can serve the purpose of supporting perishable food products for a limited period of time for example a couple of hours or so, but not for a whole day. Similarly, while camping there is sometime requirement of few essential medicines such insulin injections, which have to be kept in freezer temperature. Such items require cold packs for keeping them at that required temperature even in the absence of a freezer. These cold packs are made up of soft sealed portable plastic sac filled with water, or refrigerant gel. Gel packs are often made of non-toxic materials that will remain a slow-flowing gel, and therefore will not spill easily or cause contamination if the container breaks. Gel packs may be made by adding hydroxyethyl cellulose (Cellusize), Sodium polyacrylate, or vinyl-coated silica gel.

For use the ice packs or cold packs are frozen in a freezer. Both ice and other non-toxic refrigerants (mostly water) can absorb a considerable amount of heat before they warm above 0° C. These packs are commonly used to keep food cool in portable coolers, or as a cold compress to alleviate the pain of minor injuries; or in insulated shipping containers to keep products cool during transport. Cold packs are used in coolers to keep perishable foods (especially meats, dairy products, eggs, etc.) below the 5-75° C. (41-167° F.) danger zone when outside a refrigerator or freezer, and to keep drinks pleasantly cool.

U.S. Pat. App. No. 20090157015 discloses a vending machine body or device adapted to take payment in a variety of means and dispense sunscreen, insect repellant, hand sanitizers, or similar lotions, gels, or liquids. The sunscreen (or similar lotion, gel or liquid) may be dispensed in foil packets, plastic bladders, gel packs, or similar containers.

E.P. Pat. App. No. 1622099 discloses a method for the distribution of individual containers or “packs” individual or individual sealed envelopes (type “bags”), lightweight, small volume and containing a cold product which, once out of the area distribution, emerges from the cold. The container (or package or envelope), after use, is generally disposable. The invention provides sealed container or sealed casing (type “sachet”), in order to momentarily have a cold body by releasing the cold keeps cold or frozen to maintain an object that must remain cold or frozen as this item has not been used or taken to a location where there is a conventional cold.

U.S. Pat. No. 6,112,539 discloses a device for making, bagging, and delivering a sealed bag of ice to a consumer. The user merely deposits a specified amount of money into the coin operated vending machine and the user thereafter receives the completely sealed bag of ice. The present invention has refrigeration means which supplies ice into a hopper area having out-feed means for dispensing ice into a bagging means. The ice bagging means has a replaceable roll of plastic material which is conveyed through the machine having a cutting and heat sealing means which cuts out a bag and produces sealed ends on the bag of ice.

Thus, there is a long-felt need to provide a vending machine that can dispense frozen cold packs on demand to help keep afresh perishable food products while travelling or camping in places where freezer is not available. Therefore, in this way this invention provides a suitable solution that addresses the need for a resource or product for keeping cold the food material that is perishable in nature by keeping the cold pack underneath the food material.

### SUMMARY OF THE INVENTION

In the view of the foregoing disadvantages inherent in the known types of protective covering now present in the prior art, the present invention provides an improved protective covering. As such, the general purpose of the present invention, which will be described subsequently in greater detail, is to provide a new and improved sleeve phone case which has all the advantages of the prior art and none of the disadvantages.

An object of the invention is to provide an ice pack or a cold pack vending machine.

It is another object of the present invention to provide a cold pack vending machine having shelves and hangers to dispense frozen pack.

It is another object of the present invention to provide a cold pack vending machine that dispenses a cold pack that is dependable, durable and reusable.

It is another object of the present invention to provide a cold pack that is leak-proof.

It is yet another object of the present invention to provide a cold pack that helps keep food material cool and does not react with it.

It is another object of the present invention to provide a cold pack vending machine that can dispense cold packs of different sizes and weights.

It is another object of the present invention to provide a cold pack vending machine that has payment two slots connected with the computing system; that enable payment by cash and credit/debit card.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof Such description makes reference to the annexed drawings wherein:

FIG. 1 shows the preferred embodiment of cold pack vending machine.

FIG. 2 shows a cold pack vending machine according to an embodiment of the present invention.

FIG. 3 shows a refrigeration system inside the cold pack vending machine according to an embodiment of the present invention.

FIG. 4 shows a detailed view of a cold pack according to an embodiment of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

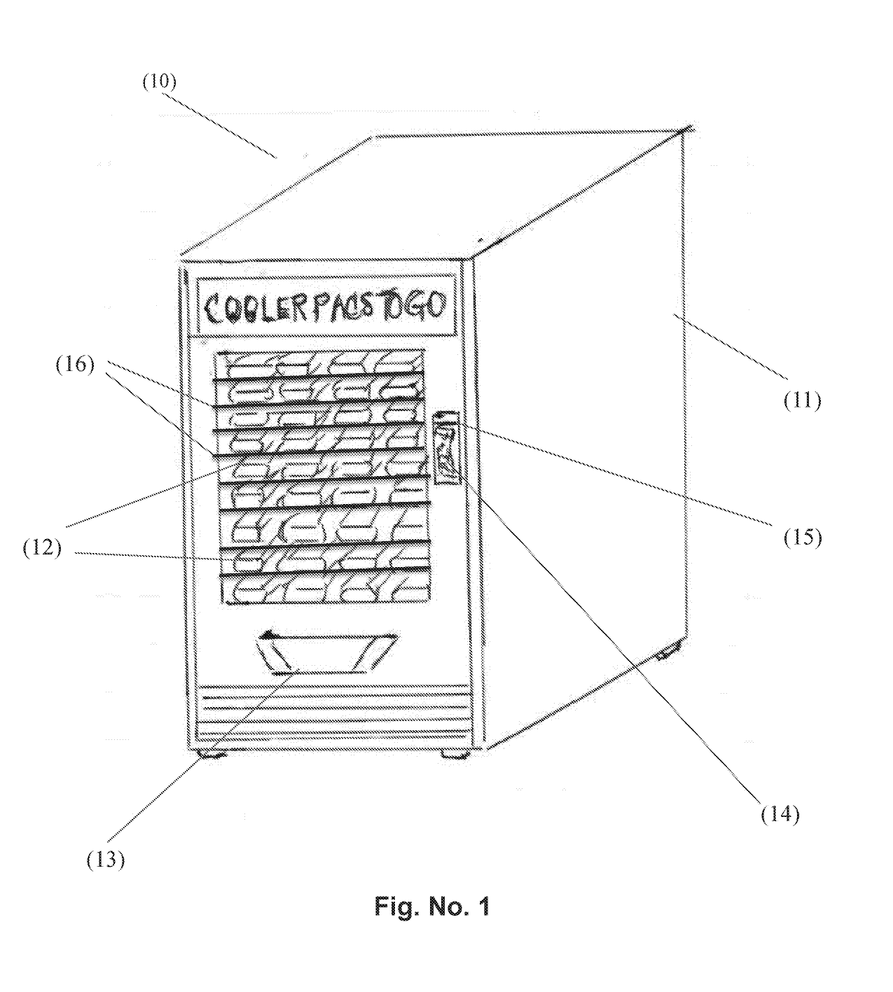

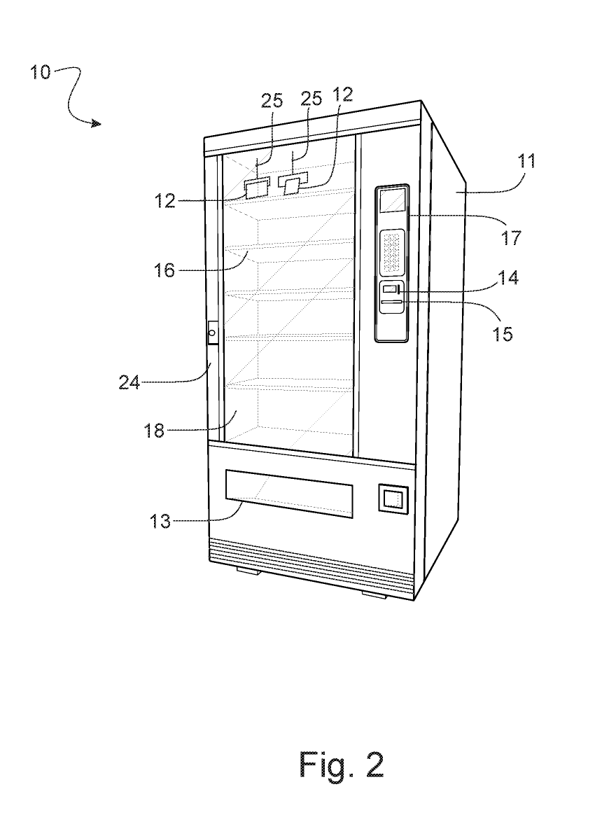

Now referring to FIGS. 1 and 2, a cold pack vending machine (10) is illustrated. The outer section or the enclosure is known as cabinet (11). It has a front door (24) which has a transparent glass (18) attached to it for displaying the contents inside the cabinet (10). The contents, cold packs (12) of different sizes and weights are placed on different shelves (16). A computing system (17) is also connected to a cold pack delivery system that consists of hangers (25). The cold pack delivery system is designed to deliver the cold pack of desired size and weight.

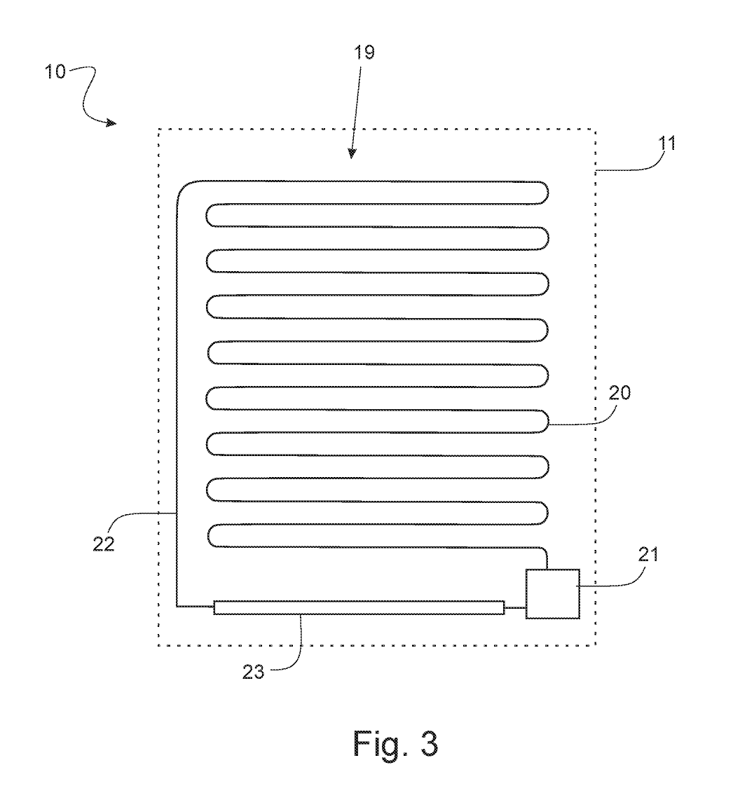

Now referring to FIG. 3, the cabinet also houses a refrigeration system (19) that has freezer elements (20,21,22,23) which help keep the cold packs (12) frozen.

The consumer has option of different modes for payment as front portion of the machine has a debit/credit card payment slot (15) and a slot for putting coins (14), at middle portion on right hand side, beside the transparent glass on front door of cabinet (11). Both the slots for payment are integrally connected to the computing system. The cold packs are delivered on cold pack receiving tray (13).

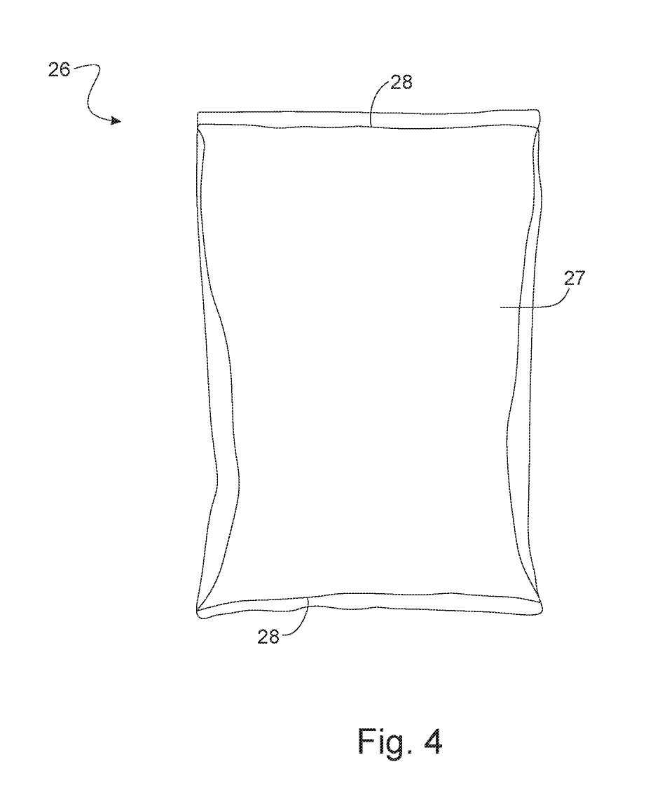

The cold pack vending machine is powered by electrical supply and the inside temperature is designed to be maintained at freezing temperature. The cold packs dispensed are made of soft sealed portable plastic sac filled with refrigerant gel. A detailed view of a cold pack (26) is illustrated in FIG. 4. As previously mentioned, the cold pack is constructed of a plastic sac (27) sealed (28) with a refrigerant gel (not shown). Gel packs are often made of non-toxic materials that will remain a slow-flowing gel, and therefore will not spill easily or cause contamination if the container breaks. Cold packs are used to keep perishable foods (especially meats, dairy products, eggs, etc.) below the 5-75° C. (41-167° F.) danger zone when outside a refrigerator or freezer.

Advantageously, the present invention is different from the existing knowledge. As it provides a preferable option over the ice pack dispensing machines as the ice melts faster due to high latent heat of vaporization of water, and hence offers comparatively less time for which food products can be kept cold and thereby enhancing its shelf life.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A cold pack vending machine comprising:
a cabinet comprising a plurality of shelves, a refrigerating system with freezer elements, a computing system, a front door, and a delivery system consisting of a plurality of hangers, wherein the front door includes transparent glass;
a plurality of cold packs on the plurality of shelves, wherein the plurality of cold packs are secured via the plurality of hangers and viewable from outside the cabinet via the transparent glass, wherein the plurality of cold packs are constructed from a soft sealed plastic sac filled with refrigerant gel consisting of different sizes;
a payment device for accepting a payment, wherein the payment device is connected to the computing system, wherein upon payment the computer system communicates with the delivery system to release a cold pack of the plurality of cold packs; and
a receiving tray designed to catch the cold pack after being released, wherein the cold pack preserves perishable foods below 5 degrees Celsius at a longer time than an ice pack.

2.-4. (canceled)

5. A cold pack vending machine according to claim 1, wherein the freezer elements keeps the plurality of cold packs frozen.

6.-7. (canceled)

8. A cold pack vending machine according to claim 1, wherein the payment device is designed to receive payment in coins.

9. A cold pack vending machine according to claim 1, wherein the payment device is designed to receive payment by debit or credit cards.

10. A cold pack vending machine according to claim 1, wherein the machine is electrically powered.

11. A method, comprising steps:
(a) providing a cabinet comprising a plurality of shelves, a refrigerating system with freezer elements, a computing system, a front door, and a delivery system consisting of a plurality of hangers, wherein the front door includes transparent glass;
(b) placing a plurality of cold packs on the plurality of shelves, wherein the plurality of cold packs are secured via the plurality of hangers and viewable from outside the cabinet via the transparent glass, wherein the plurality of cold packs are constructed from a soft sealed plastic sac filled with refrigerant gel consisting of different sizes and weights;
(c) accepting a payment for a cold pack of the plurality of cold packs via a payment device, wherein a the payment device is connected to the computing system, wherein upon payment the computer system communicates with the delivery system to release the cold pack; and
(d) receiving the cold pack upon a receiving tray, wherein the cold pack preserves perishable foods below 5 degrees Celsius at a longer time than an ice pack.

12.-15. (canceled)
